(19) United States
(12) Patent Application Publication
(10) Pub. No.: US 2026/0081849 A1
(43) Pub. Date: Mar. 19, 2026

(54) SD-WAN TRAFFIC ENGINEERING

(71) Applicant: Huawei Technologies Co., Ltd., Shenzhen (CN)

(72) Inventor: Linda Dunbar, Plano, TX (US)

(21) Appl. No.: 19/402,324

(22) Filed: Nov. 26, 2025

Related U.S. Application Data
(63) Continuation of application No. PCT/US2024/031612, filed on May 30, 2024.
(60) Provisional application No. 63/505,310, filed on May 31, 2023.

(51) Int. Cl. H04L 41/40; H04L 45/74

(52) U.S. Cl. CPC H04L 41/40; H04L 45/74

(57) ABSTRACT

A method implemented by a first edge node of a software-defined wide area network (SD-WAN) for steering traffic over an SD-WAN path. The first edge node receives, on a control plane, first gateway (GW) properties of a first adjacent SD-WAN gateway of a second edge node of the SD-WAN, wherein the first edge node is an authorized peer of the second edge node, and the first adjacent SD-WAN gateway satisfies a first policy of the second edge node. The first edge node generates, based on the first GW properties, a data packet containing header information for steering the data packet to the second edge node over an SD-WAN path comprising the first adjacent SD-WAN gateway. The first edge node transmits, on a data plane, the data packet to a next hop along the SD-WAN path as indicated by an outer Internet Protocol (IP) destination address of the data packet.

### CROSS-REFERENCE TO RELATED APPLICATIONS

This application is a continuation of International Patent Application No. PCT/US2024/031612 filed on May 30, 2024, which claims priority to U.S. Provisional Application No. 63/505,310 filed on May 31, 2023, which are hereby incorporated by reference in their entireties.

### TECHNICAL FIELD

The present disclosure relates to relates generally to a software-defined networking (SDN) wide area network (WAN) (SD-WAN), and more particular to systems and methods for SD-WAN Traffic Engineering (TE).

### BACKGROUND

A WAN is a large computer network that connects groups of computers over large distances. WANs are often used by large businesses to connect their office networks. Each office typically has its own local area network (LAN). The LANs are connected via a WAN to enable communications between the various offices. Typically, a dedicated leased line is used to help ensure security and reliable connectivity. A leased line is a direct network connection rented from a large network provider such as an Internet service provider (ISP).

SDN is an approach to networking that uses software-based controllers or application programming interfaces (APIs) to communicate with underlying hardware infrastructure and direct traffic on a network. SDN differs from that of traditional networks, which use dedicated hardware devices (i.e., routers and switches) to control network traffic. SDN can create and control a virtual network or a traditional hardware network via software.

SDN can be applied to a WAN to create a SD-WAN. A SD-WAN enables a flexible WAN architecture that can take advantage of multiple hardware platforms and connectivity options. SD-WAN is widely deployed to connect enterprises' customer premises equipment (CPEs) with services in Cloud data centers (DCs). With a SD-WAN, administrators can configure network services and allocate virtual resources to change the network infrastructure in real time through one centralized location. This allows network administrators to optimize the flow of data through the network and prioritize applications that require more availability.

### SUMMARY

A first aspect relates to a method implemented by a first edge node of a SD-WAN. The method includes receiving, on a control plane, first gateway (GW) properties of a first adjacent SD-WAN gateway of a second edge node of the SD-WAN, wherein the first edge node is an authorized peer of the second edge node, and wherein the first adjacent SD-WAN gateway satisfies a first policy of the second edge node; generating, based on the first GW properties, a data packet containing header information for steering the data packet to the second edge node through a SD-WAN path comprising the first adjacent SD-WAN gateway; and transmitting, on a data plane, the data packet to a next hop along the SD-WAN path as indicated by an outer Internet Protocol (IP) destination address of the data packet.

Optionally, in a first implementation according to the first aspect, the method further includes selecting, based on a second policy of the first edge node, a second adjacent SD-WAN gateway from a plurality of adjacent SD-WAN gateways of the first edge node; and advertising second GW properties of the second adjacent SD-WAN gateway.

Optionally, in a second implementation according to the first aspect or any implementation thereof, the first policy or the second policy comprises selecting at least one of a shortest distance SD-WAN gateway to the first edge node, a lowest cost SD-WAN gateway of the first edge node, a most secure SD-WAN gateway of the first edge node, or a most optimized SD-WAN gateway.

Optionally, in a third implementation according to the first aspect or any implementation thereof, the first GW properties are encoded in at least one of a client route UPDATE message and a SD-WAN UPDATE message.

Optionally, in a fourth implementation according to the first aspect or any implementation thereof, the client route UPDATE message comprises an Encapsulation Extended Community and a Color Extended Community to link with a SD-WAN Tunnels UPDATE Message, and wherein a SD-WAN-Hybrid Tunnel Type Encoding is added and used by the Encapsulation Extended Community or a Tunnel-Encapsulation Path Attribute to indicate mixed underlay networks.

Optionally, in a fifth implementation according to the first aspect or any implementation thereof, the SD-WAN-Hybrid Tunnel Type Encoding comprises an Adjacent-Gateway Sub-Type-Length-Value (sub-TLV) to identify the first adjacent SD-WAN gateway.

Optionally, in a sixth implementation according to the first aspect or any implementation thereof, the SD-WAN UPDATE message comprises a SD-WAN network layer reachability information (NLRI) for advertising the first GW properties of the first adjacent SD-WAN gateway.

Optionally, in a seventh implementation according to the first aspect or any implementation thereof, generating the data packet comprises: encapsulating an encrypted payload of the data packet with a Generic Network Virtualization Encapsulation (GENEVE) encapsulation header; encoding a multi-segment SD-WAN option class in the GENEVE encapsulation header; and encoding a SD-WAN Tunnel Endpoint sub-TLV in the multi-segment SD-WAN option class to indicate a destination CPE of an IPsec Tunnel along the SD-WAN path.

Optionally, in an eighth implementation according to the first aspect or any implementation thereof, the method further includes encoding a SD-WAN Tunnel Originator sub-TLV in the multi-segment SD-WAN option class to indicate an originating CPE of the IP Security (IPsec) Tunnel.

Optionally, in a ninth implementation according to the first aspect or any implementation thereof, the method further includes encoding an Include Transit Sub-TLV in the multi-segment SD-WAN option class to explicitly include a first list of cloud availability transit nodes, regions, or zones in the SD-WAN path.

Optionally, in a tenth implementation according to the first aspect or any implementation thereof, the method further includes encoding an Exclude Transit Sub-TLV in the multi-segment SD-WAN option class to explicitly exclude a second list of cloud availability transit nodes, regions, or zones in the SD-WAN path.

Optionally, in an eleventh implementation according to the first aspect or any implementation thereof, the method further includes encoding an egress GW sub-TLV in the multi-segment SD-WAN option class to specify an egress GW for reaching the destination CPE.

Optionally, in a twelfth implementation according to the first aspect or any implementation thereof, the method further includes encrypting the encrypted payload of the data packet using IPsec Encapsulating Security Payload (ESP) Tunnel Mode.

A second aspect relates to a method implemented by a transit GW of a SD-WAN. The method includes receiving a GENEVE encapsulated packet; authenticating the GENEVE encapsulated packet; extracting a destination CPE address from the GENEVE encapsulated packet; replacing an outer IP destination address of the GENEVE encapsulated packet with the destination CPE address; and transmitting the GENEVE encapsulated packet to a next hop along a SD-WAN path as indicated by the outer IP destination address.

Optionally, in a first implementation according to the second aspect, the method further includes replacing an outer IP source address of the GENEVE encapsulated packet with an address of the Transit GW.

Optionally, in a second implementation according to the second aspect or any implementation thereof, the method further includes extracting the destination CPE address from a SD-WAN Tunnel Endpoint sub-TLV in a multi-segment SD-WAN option class encoding of the GENEVE encapsulated packet.

Optionally, in a third implementation according to the second aspect or any implementation thereof, the method further includes authenticating the GENEVE encapsulated packet using a digital signature or hash-based message authentication code (HMAC).

Optionally, in a fourth implementation according to the second aspect or any implementation thereof, the GENEVE encapsulated packet indicates a GENEVE Protocol Type value of 50 corresponding to IPsec ESP.

A third aspect relates to a method implemented by a SD-WAN controller. The method includes establishing secure connections to edge nodes of the SD-WAN; receiving Border Gateway Protocol (BGP) UPDATE messages comprising adjacent GW information of an adjacent SD-WAN gateway of a first edge node, wherein the adjacent SD-WAN gateway satisfies a policy of the first edge node; determining authorized peers of the first edge node; and propagating the adjacent GW information to the authorized peers.

Optionally, in a first implementation according to the third aspect, the BGP UPDATE messages comprise a client route UPDATE message and a SD-WAN UPDATE message.

Optionally, in a second implementation according to the third aspect or any implementation thereof, the client route UPDATE message comprises an Encapsulation Extended Community and a Color Extended Community to link with a SD-WAN Tunnels UPDATE Message, and wherein the Encapsulation Extended Community or a Tunnel-Encapsulation Path Attribute comprises a SD-WAN-Hybrid Tunnel Type Encoding to indicate mixed underlay networks.

Optionally, in a third implementation according to the third aspect or any implementation thereof, the SD-WAN-Hybrid Tunnel Type Encoding comprises an Adjacent-Gateway sub-TLV to identify an adjacent SD-WAN gateway of the first edge node.

Optionally, in a fourth implementation according to the third aspect or any implementation thereof, the SD-WAN UPDATE message comprises a SD-WAN NLRI for advertising properties of the adjacent SD-WAN gateway.

A fourth aspect relates to an apparatus comprising a memory or storage means configured to store instructions; and one or more processors or processing means coupled to the memory or the storage means and configured to execute the instructions to cause the apparatus to perform the method according to any of the preceding aspects or any implementation thereof.

A fifth aspect relates to a computer program product comprising computer-executable instructions stored on a non-transitory computer-readable storage medium, the computer-executable instructions when executed by one or more processor of an apparatus, cause the apparatus to perform the method according to any of the preceding aspects or any implementation thereof.

For clarity, any one of the foregoing embodiments may be combined with any one or more of the other foregoing embodiments to create a new embodiment within the scope of the present disclosure.

These and other features, and the advantages thereof, will be more clearly understood from the following detailed description taken in conjunction with the accompanying drawings and claims.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a diagram illustrating a network according to an embodiment of the present disclosure.

FIG. 2 is a diagram illustrating an encrypted packet according to an embodiment of the present disclosure.

FIG. 3 is a diagram illustrating an edge discovery process according to an embodiment of the present disclosure.

FIG. 4 is a diagram of an SD-WAN NLRI according to an embodiment of the present disclosure.

FIG. 5 is a diagram of an SD-WAN NLRI according to an embodiment of the present disclosure.

FIG. 6 is a diagram of an Adjacent Gateway sub-Type-Length-Value (TLV) according to an embodiment of the present disclosure.

FIG. 7 is a diagram of a packet according to an embodiment of the present disclosure.

FIG. 8 is a diagram of a GENEVE header according to an embodiment of the present disclosure.

FIG. 9 is a diagram of a multi-seg-SD-WAN Option Class according to an embodiment of the present disclosure.

FIG. 10 is a diagram of a SD-WAN Tunnel Endpoint sub-TLV according to an embodiment of the present disclosure.

FIG. 11 is a diagram of a SD-WAN Tunnel Originator sub-TLV according to an embodiment of the present disclosure.

FIG. 12 is a diagram of an Include Transit Sub-TLV according to an embodiment of the present disclosure.

FIG. 13 is a diagram of an Exclude Transit Sub-TLV according to an embodiment of the present disclosure.

FIG. 14 is a diagram of an egress GW sub-TLV according to an embodiment of the present disclosure.

FIG. 15 is a flow chart of a process for SD-WAN TE according to an embodiment of the present disclosure.

FIG. 16 is a flow chart of a process for SD-WAN TE according to an embodiment of the present disclosure.

FIG. 17 is a flow chart of a process for SD-WAN TE according to an embodiment of the present disclosure.

FIG. 18 is a diagram illustrating an apparatus according to an embodiment of the present disclosure.

### DESCRIPTION OF EMBODIMENTS

It should be understood at the outset that, although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various systems and methods for SD-WAN TE. SD-WAN TE refers to the capability to control network traffic flows of an SD-WAN. In particular, the present disclosure enables steering a traffic flow (e.g., service flows or application flows) through a SD-WAN path that may include an untrusted underlay network. Service flows or application flows describe how data flows are communicated between network endpoints to deliver a particular service or application functionality. Aspects of service flows or application flows encompass end-to-end communication including data transmission, routing, prioritizing, resource allocation, monitoring, optimization, security, and processing of packets at various network nodes along a path between the network endpoints.

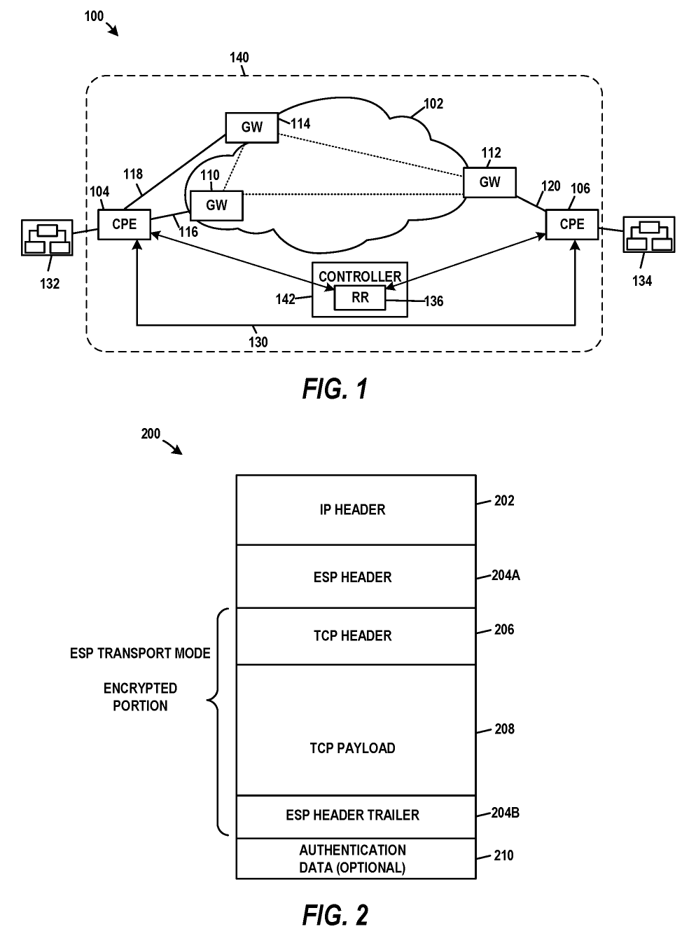

FIG. 1 is a diagram illustrating a network 100 according to an embodiment of the present disclosure. The network 100 uses a cloud backbone 102 (or cloud 102) for providing an underlay network of a SD-WAN 140. An underlay network refers to a physical network infrastructure that provides connectivity and transport services for higher-level network overlays or virtual networks. As stated above, SDN is an approach to networking that uses software-based controllers or APIs to communicate with underlying hardware infrastructure and direct traffic on a network. SDN can be used to create the SD-WAN 140. The SD-WAN 140 is configured to provide policy-driven transporting of IP packets over multiple underlay networks for better WAN bandwidth management, visibility, and control. In the present disclosure, the SD-WAN 140 may be referred to as a hybrid SD-WAN when the SD-WAN 140 includes a mix of different types of underlay networks (e.g., the underlay networks includes a private Multiprotocol Label Switching (MPLS) virtual private network (VPN) and the public internet (referred to herein as the Internet)).

In an embodiment, a controller 142 (or SD-WAN controller) is configured to manage, configure, monitor, and troubleshoot the network infrastructure of the SD-WAN 140. For example, the controller 142 can manage SD-WAN overlay path creation/deletion and monitor the path conditions between sites. In some embodiments, the controller 142 includes a route reflector (RR) 136. RR 136 is a component or function of the controller 142 that is configured to exchange routing information among routers of the SD-WAN 140. In an embodiment, the RR 136 is designed to optimize BGP routing updates and improve the efficiency of routing information distribution within the SD-WAN 140 overlay network. BGP, as described in Request for Comments (RFC) document 4271 titled “A Border Gateway Protocol 4 (BGP-4)” published January 2006 (RFC4271), is a routing protocol that is used to exchange NLRI. NLRI specifies the IP prefixes (e.g., network addresses and their associated subnet masks) that are reachable by a router and how they can be reached. NLRI is exchanged between BGP routers using UPDATE messages. For example, the RR 136 may be configured to receive BGP UPDATE messages from SD-WAN edges as described below and propagate the NLRI to the intended peers that are authorized to communicate via the SD-WAN 140 overlay network. In some embodiments, the SD-WAN 140 may include additional RRs that are not part of the controller 142. For example, the SD-WAN 140 may include one or more local RRs. Each local RR is responsible for exchanging routing information among routers within a certain range (i.e., hops) of the local RR.

In an embodiment, the cloud 102 is a network infrastructure of a cloud provider that can be used to interconnect CPEs such as, but not limited to, CPE 104 and CPE 106 in FIG. 1. The cloud 102 may include various public and private networks such as the Internet, virtual private clouds (VPCs), a wireless WAN, virtual private networks (VPNs), a private MPLS, and other cloud resources. To ensure security, enterprise traffic between their CPEs is encrypted and remains inaccessible to any third party. The cloud 102 may span multiple regions allowing for global connectivity and the ability to deliver services to users worldwide. A region refers to a logical grouping of network locations or sites that share common characteristics or policies. These characteristics can include factors like geographical location, network performance requirements, security policies, or business priorities. For example, a multinational company might have multiple offices across different continents. They could group their North America offices in into one region, their European offices in into another region, and so on. Each region can then have its own set of rules and configurations within the SD-WAN, such as prioritizing certain types of traffic, applying specific security measures, or defining routing policies tailored to the needs of a particular region.

A CPE is a telecommunications device (e.g., a router or switch) that is installed at a customer’s location. The CPE serves as the point of connection between a LAN and the SD-WAN 140. In FIG. 1, CPE 104 serves as the point of connection between a LAN 132 and the SD-WAN 140. Similarly, CPE 106 serves as the point of connection between a LAN 134 and the SD-WAN 140. A CPE connected to the SD-WAN 140 may be referred herein as an SD-WAN edge or edge node. In an embodiment, CPE 104 and CPE 106 are configured to connect to the SD-WAN 140 by establishing connections with one or more transit gateways (GWs) or gateway instances (i.e., virtualized gateways) of the cloud 102. A transit GW (or just GW as referred to herein) is a network node device or software component that serves as a bridge or hub between different networks. A GW may include security features such as firewalls and intrusion detection/prevention systems to help protect networks from unauthorized access and malicious attacks. The GW may use routing tables or routing protocols to determine the best path for data packets to reach their destination across different networks based on factors like network congestion, availability, and cost.

As illustrated in FIG. 1, SD-WAN 140 is configured to enable the setup of multiple links or paths from an edge node to a GW of the cloud 102. For example, in the depicted embodiment, CPE 104 has a connection/path 116 with GW 110 and a connection/path 118 with GW 114, and CPE 106 has a connection/path 120 with GW 112. Each path represents a dual (bidirectional) tunnel connection from a unique public IP address of the edge node to the GW. For example, between CPE 104 and GW 110, there may be a bidirectional IPsec tunnel having IPsec Security Associations (SA) SA1 for the traffic in one direction (e.g., from CPE 104 to GW 110) and IPsec SA2 for in the other direction (e.g., the traffic from GW 110 to CPE 104). IPsec SAs defines security parameters for inbound or outbound traffic. In an embodiment, GW 110 and GW 112 are located in different regions. Additionally, each GW may also be connected to other CPEs. GW 110 and GW 112 are directly or indirectly connected to each other, or other GWs (e.g., GW 114) or internal transit nodes in the SD-WAN 140, to enable communications between CPE 104 and CPE 106. In some embodiments, the connections between a CPE to a GW, and a GW to a GW, may be a dedicated secured connection (e.g., through a service provider network) or an unsecured network connection that relies on an unsecured network such as the Internet. In addition, in some embodiments, the same CPE may have different types of connection/paths to different GWs. As an example, connection 116 between CPE 104 and GW 110 may be a dedicated/direct secured path (i.e., private circuit), while connection 118 between CPE 104 and GW 110 may be an unsecured path. In some embodiments, SD-WAN 140 is a hybrid SD-WAN that is able to connect traffic from a direct secured connection to an unsecured network connection (e.g., an IPsec tunnel). For example, assume an IPsec tunnel is established over an unsecured network for the connection 120 between CPE 106 and GW 112, and that connection 116 between CPE 104 and GW 110 is a direct secured connection, then SD-WAN 140 can connect the traffic from connection 116 to connection 120 via GW 110 and GW112 to form a hybrid path or tunnel comprising mixed (secured and non-secured) underlay networks.

In an embodiment, when CPE 104 and CPE 106 belong to the same network domain that is under the control of a single administrative entity such as a large organization or network operator, the control plane enables edge nodes to discover their properties and attached routes. The control plane is the part of a network that controls how data is forwarded. The control pane handles tasks such as routing protocols, network topology discovery, and traffic management policies. The data plane or forwarding plane is responsible for forwarding data packets from one network device to another based on the information provided by the control plane. For example, CPE 104 and CPE 106 can establish on the control plane an Internal BGP (iBGP) session 130 to each other. The iBGP session 130 is used to exchange routing information such as, but not limited to, the GWs of the cloud 102 that are connected to the respective CPE. In some embodiments, instead of establishing an iBGP session directly between CPE 104 and CPE 106, CPE 104 and CPE 106 may establish an iBGP session with the RR 136 that is configured to distribute the routing information to other CPE/peer devices. An external BGP (eBGP) session can be established between CPEs and GWs to distribute routing information between to the CPEs and GWs.

For example, there may be a first overlay or SD-WAN path established between CPE 104 and CPE 106 using the node IP addresses of CPE 104 and CPE 106 (i.e., a node-based IPsec tunnel), a second overlay or SD-WAN path established between CPE 104 and CPE 106 using an IP address of a first Internet facing WAN port of the CPE 104 and an IP address of a first Internet facing WAN port of the CPE 106 (i.e., a port-based IPsec tunnel), and a third overlay or SD-WAN path established between CPE 104 and CPE 106 using an IP address of a second Internet facing WAN port of the CPE 104 and an IP address of a second Internet facing WAN port of the CPE 106. More overlay paths are possible between CPE 104 and CPE 106 such as an MPLS-in-General Routing Encapsulation (GRE) path or a port-based IPsec tunnel using the IP address of the first Internet facing WAN port of the CPE 104 with the IP address of the second Internet facing WAN port of the CPE 106. Currently, the edge nodes of a path or tunnel are responsible for selecting the desired underlay network path between them. When an unsecured network (such as the Internet) is part of the selected underlay network path between the edge nodes, to ensure the confidentiality, integrity, and availability of communication among CPEs, the traffic between the CPEs should be encrypted by using IPsec SAs. The CPEs are configured to establish IPsec Security Associations (SAs) between each other. For example, IPsec SAs may be established through a negotiation process between the CPE 104 and CPE 106 over a secure communication channel between the CPEs using IPsec protocols such as Internet Key Exchange (IKE) or IKE version 2 (IKEv2).

FIG. 2 is a diagram illustrating an encrypted packet 200 according to an embodiment of the present disclosure. As stated above, to ensure security, enterprise traffic between their CPEs is encrypted. The encrypted packet 200 is an example of a IP packet that is generated by an edge node (e.g., CPE 104 in FIG. 1) after IPsec SAs are established between the edge nodes (e.g., CPE 104 and CPE 106 in FIG. 1). In the depicted embodiment, the encrypted packet 200 uses an ESP protocol header to encapsulate and encrypt a packet payload when an unsecured network is part of the selected underlay network path between the edge nodes. The ESP protocol is one of the IPsec protocols that can be used to encrypt and authenticate packets. The packet 200 includes an IP header 202, an ESP header 204A, a Transmission Control Protocol (TCP) header 206, a payload 208, an ESP header trailer 204B (or simply, ESP header 204B), and an authentication header (AH) 210. The AH 210 is an optional header (i.e., may be excluded from the encrypted packet 200).

The IP header 202 may be an IP version 4 (IPv4) header or an IP version 6 (IPv6) header. The IP header 202 includes a source IP address and a destination IP address. The source IP address is the IP address of the edge node that is sending the encrypted packet 200. The destination IP address is the IP address of the edge node intended to receive the encrypted packet 200. The unsecured network (e.g., the Internet) forwards the encrypted packet 200 based on the destination address, just like all other packets, with the best effort intention. The IP header 202 also includes a Protocol (IPv4) or Next Header (IPv6) field containing a value 50 assigned to the ESP protocol to indicate the ESP header 204 is the next header in the encrypted packet 200 after the IP header 202. In some embodiments, there may be one or more extension headers (e.g., routing, fragmentation, etc.) between the IP header 202 and the ESP header 204. In those embodiments, the Protocol (IPv4) or Next Header (IPv6) field indicates the next extension header in the encrypted packet 200 after the IP header 202, and the extension header immediately preceding the ESP header 204 will contain the value 50 in its Next Header field.

The ESP header 204A is designed to provide a mix of security services in IPv4 and IPv6. ESP may be applied alone or in combination with the AH 210. The ESP header 204 carries data for providing encryption of the data. The ESP header 204A includes a Security Parameters Index (SPI) and a sequence number. The SPI is used to uniquely identify the SA of the encrypted packet 200. The sender’s counter and the receiver’s counter are initialized to 0 when an SA is established. The first packet sent using a given SA will have a sequence number of 1.

The TCP header 206 is an upper-layer-protocol header or IP transport protocol header. The TCP header 206 is used to carry a source port, a destination port, sequence number, data offset, and other information. The source port is used to identify the sending application or process within the source device. The destination port is used to identify the receiving application or process within the destination device. The TCP header 206 plays a crucial role in establishing, maintaining, and terminating TCP connections, ensuring reliable, ordered, and error-checked data transfer between network devices. In some embodiments, the encrypted packet 200 may have a different upper-layer-protocol header such as the User Datagram Protocol (UDP) or the Internet Control Message Protocol (ICMP).

The TCP payload 208 carries the application data or service data being transmitted from the source device to the destination device.

As described below, the ESP header 204B can include padding (variable length) after an encrypted payload to allow block-oriented encryption algorithms room for multiples of their block size. The ESP header 204B also includes pad length field after the padding and a next header field. The pad length field indicates a length of the padding in the ESP header 204B. The Next Header field indicates the type (e.g., IP, TCP, UDP, etc.) of the payload of the encrypted packet 200. For instance, the Next Header field in the ESP header 204B would indicate TCP for the TCP payload 208 of the encrypted packet 200.

The AH 210 is an optional header that can be used to provides data authentication. The AH 210 includes an Integrity Check Value (ICV) obtained by the source device by computing a cryptographic hash using data from certain fields of the encrypted packet 200. The destination device can perform the same computation using data from the same fields of the encrypted packet 200 to authenticate the data of the encrypted packet 200. The data is authenticated when the value computed by the destination device matches the ICV.

ESP may be employed in tunnel mode or transport mode. Tunnel mode is used to provide a virtual “secure hop” between two gateways (e.g., GW 110 and GW 112 in FIG. 1). Tunnel mode is used in virtual private networks (VPNs), where a secure tunnel can be created across an untrusted network (e.g., the Internet). In tunnel mode, the entire packet 200 is encrypted and authenticated (i.e., the entire packet 200 is encapsulates inside an encrypted shell). Transport mode is used to protect an end-to-end conversation between two hosts (e.g., CPE 104 and CPE 106 in FIG. 1). In transport mode, as illustrated in FIG. 2, only the upper layer protocol header (i.e., the TCP header 206), the TCP payload 208, and the ESP header 204B are encrypted. The IP header 202 remains unencrypted. By not encrypting the IP header 202, the transit nodes along a path can steer the encrypted packet 200 based on the destination IP address in the IP header 202 without the need for decryption and re-encryption of the encrypted packet 200. Thus, processing demands at the GWs or transit nodes can be significantly reduced. This approach not only maintains the integrity of the encrypted traffic but also optimizes processing resources and enhancing overall efficiency within the cloud infrastructure.

One problem with SD-WAN is the issue of unpredictable flow paths. For instance, if the encrypted packet 200 is sent from a CPE to a GW over a path that includes an unsecured network such as the Internet, the Internet can route the encrypted packet 200 over unpredictable network paths using best efforts based on the destination IP address specified in the IP header 202. For example, a packet may be routed or rerouted based on network congestion or if a particular router fails. Thus, although the encrypted packet 200 is protected using encryption, when the encrypted packet 200 is forwarded over a SD-WAN path with an underlying unsecured network such as the Internet, there may be increased latency or other issues (e.g., due to cyber-attacks, network congestion, packets being forwarded using different routes, etc.). Additionally, as stated above, in some embodiments, an edge node may have both a dedicated secured connection to a first GW (e.g., through a service provider SD-WAN or other network) and an unsecured connection path to a second GW. For example, an edge node may be configured to use the dedicated secured connection and first GW for certain types of data, and use the unsecured connection and second GW for other types of data. Thus, it would be beneficial to be able to steer the traffic flow of a service or application to the edge node through a particular SD-WAN path (i.e., particular transit nodes and connections). Current methods for steering traffic through a particular path include Segment Routing IPv6 (SRv6) or MPLS-TE. However, the current traffic steering methods are effective only when the entire network domain is under one administrative control (e.g., within an autonomous system (AS)). Thus, the current traffic steering methods cannot be applied to a SD-WAN because the underlay networks of an SD-WAN path may include a mix of different types of network that are not under one administrative control (e.g., the Internet). Accordingly, the present disclosure describes various systems and methods for steering traffic flow of a service or application through a SD-WAN path.

As described in FIG. 1, some SD-WAN peers may be connected by both trusted VPNs and untrusted public networks, while other SD-WAN peers may be connected only by untrusted public networks. When an SD-WAN path for carrying traffic between edge nodes uses an underlying untrusted (i.e., unsecured) network, a secure overlay tunnel (e.g., an IPsec tunnel) must be established and maintained between the edge nodes. Secure overlay tunnels that span both trusted networks (e.g., MPLS VPN) and untrusted networks (e.g., the Internet) are referred to as SD-WAN hybrid tunnels. In an embodiment, in order to establish the secure overlay tunnels, edge nodes are configured to perform an edge discovery process to discover its authorized peers and their associated properties.

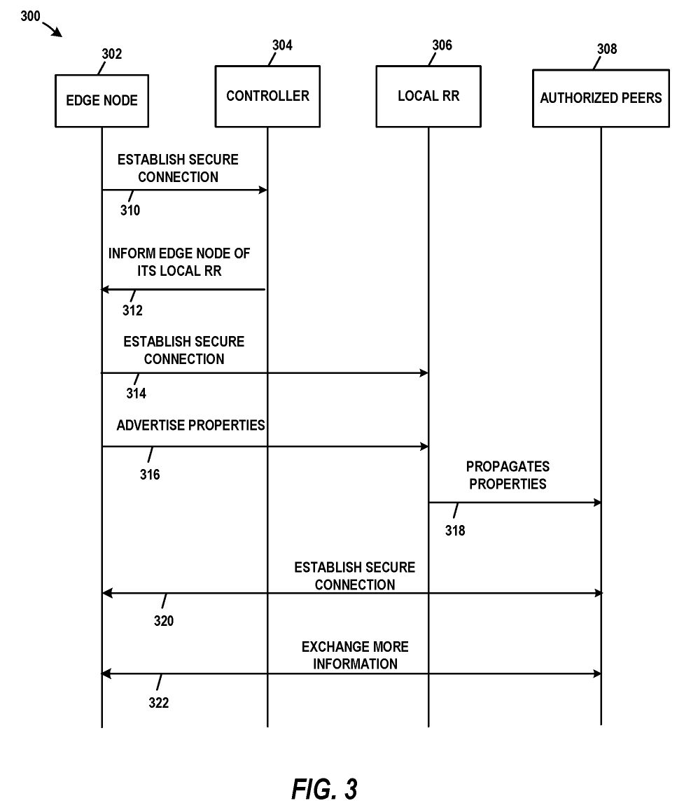

FIG. 3 is a diagram illustrating an edge discovery process 300 according to an embodiment of the present disclosure. The edge node discovery process 300 begins, at step 310, with an edge node 302 (e.g., CPE 104 in FIG. 1) establishing a secure connection to a controller 304 (e.g., controller 142 in FIG. 1). For an edge node 302 with both MPLS and IPsec paths, the edge node 302 may already have a secure connection to the controller 304, in which case the existing secure connection may be used for the edge discovery process. In some embodiments, for an edge node 302 that is only accessible via the Internet, the edge node 302, upon power-up, is configured to establish a secure tunnel (such as Transport Layer Security (TLS) or Secure Sockets Layer (SSL)) with the controller 304 whose address is preconfigured on the edge node 302. At step 312, the controller 304 informs the edge node 302 of a local RR 306 of the edge node 302. As described above, the local RR 306 may be a RR that is located closer to the edge node 302 and is configured to receive and distribute routing information for designated edge nodes assigned to the local RR 306. In some embodiments, the local RR 306 of the edge node 302 may be part of the controller 304.

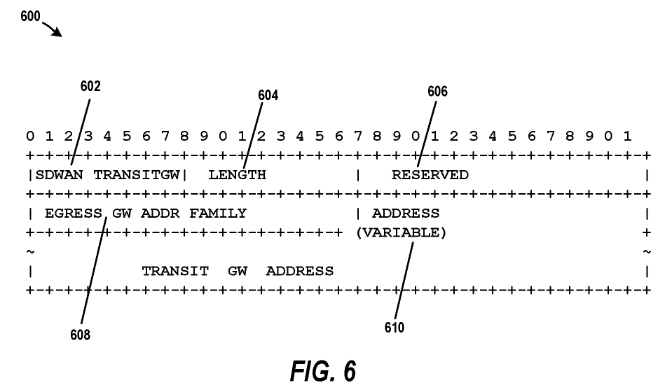

The edge node 302, at step 314, establishes a transport layer secure session (e.g., TLS or SSL) with the local RR 306 based on the information provided by the controller 304. The edge node 302, at step 316, advertises in BGP UPDATE messages, on the control plane via the secure connection, the properties of the edge node 302 to the local RR 306. Non-limiting examples of properties may include, but are not limited to, the SD-WAN (client) VPNs information, the attached routes under the SD-WAN VPNs, the properties of the underlay networks over which the client routes can be carried, and/or other information (e.g., if an edge has network ports behind a Network Address Translation (NAT), the NAT properties (e.g., capabilities) are advertised to the authorized SD-WAN peers). In some embodiments, the edge discovery process uses two separate BGP UPDATE messages, a client route UPDATE message and a SD-WAN UPDATE message. In an embodiment, the client route UPDATE message uses the Encapsulation Extended Community and the Color Extended Community to link with a SD-WAN Tunnels UPDATE Message as specified in RFC document 9012 titled “The BGP Tunnel Encapsulation Attribute” published April 2021 (RFC9012). A new Tunnel Type (Tunnel Type=SD-WAN-Hybrid), as described in Internet-Draft: draft-ietf-idr-sdwan-edge-discovery-12, titled “BGP UPDATE for SD-WAN Edge Discovery” published on October 14, 2023, is added and used by the Encapsulation Extended Community or the Tunnel- Encapsulation Path Attribute, as described in RFC9012, to indicate mixed underlay networks. A new attribute (Adjacent-Gateway sub-TLV)), as described in FIG. 6, is added to the SD-WAN-Hybrid Tunnel Encoding to identify a GW directly connected to an edge node. In an embodiment, the SD-WAN UPDATE message is used by an edge node to advertise the properties of directly attached underlay networks, including the NAT information, pre-configured IPsec SA identifiers, underlay network specific information, properties of Internet facing ports, properties associated with the WAN ports and IPsec tunnels, and detailed IPsec SA attributes such as keys, nonce, encryption algorithms, etc. The local RR 306, at step 318, propagates the received property information of the edge node 302 to authorized peers 308 of the edge node 302 (e.g., CPE 106 in FIG. 1 may be an authorized peer of CPE 104).

At step 320, the edge node 302 and its authorized peers 308 can establish one or more secure data channels (e.g., IPsec tunnel) using the information distributed by the local RR 306. The edge node 302 and its authorized peers 308, at step 322, can exchange data among each other using the secure data channels.

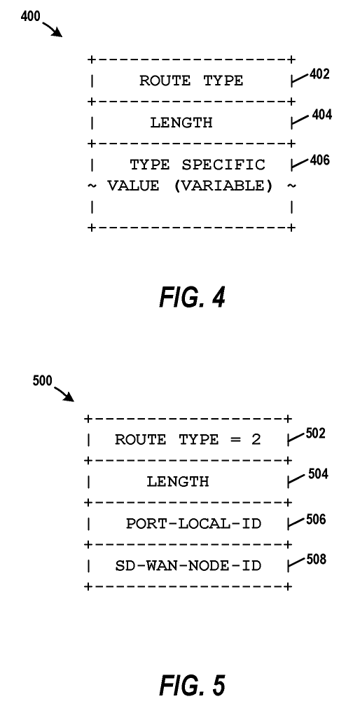

FIG. 4 is a diagram of an SD-WAN NLRI 400 according to an embodiment of the present disclosure. The SD-WAN NLRI 400 is used to advertise SD-WAN Capabilities and is assigned NLRI Subsequent Address Family Identifier (SAFI) value 74 by the Internet Assigned Numbers Authority (IANA). In an embodiment, the SD-WAN NLRI 400 can be encoded within an MP_REACH_NLRI Path Attribute (with SAFI=74), as described in RFC document 4760 titled “Multiprotocol Extensions for BGP-4” published January 2007 (RFC4760), for advertising in a SD-WAN UPDATE message (e.g., at step 316 in FIG. 3) the detailed properties of the transit gateways for the an edge node (e.g., GW 110 of CPE 104 in FIG. 1).

The SD-WAN NLRI 400 comprises a route type field 402, a length field 404, and a type specific value field 406. The route type field 402 is a 2 octet field that carries a value to indicating route type (e.g., route type=1 is for advertising the detailed properties of the SD-WAN tunnels terminated at the edge node). The encoding of the rest of the SD-WAN NLRI 400 depends on the route type indicated in the route type field 402. The length field 404 is a 2 octet field that indicates a length expressed in bits as defined in RFC4760. The type specific value field 406 carries the properties being advertised, which depends on the route type indicated the route type field 402.

FIG. 5 is a diagram of an SD-WAN NLRI 500 according to an embodiment of the present disclosure. The SD-WAN NLRI 500 is an example of the SD-WAN NLRI 400 in FIG. 4. The SD-WAN NLRI 500 comprises a route type field 502, a length field 504, a port-local-identifier (ID) field 506, and a SD-WAN-node-ID field 508. The route type field 502 carries SD-WAN NLRI route-type = 2. In an embodiment, route-type 2 is for advertising the detailed properties of adjacent GWs of an edge node. An adjacent GW is a GW that is directly connected (i.e., reachable over a single network hop) to the edge node. As shown in FIG. 1, an edge node may have multiple adjacent GWs. As further described herein, in some embodiments, an edge node may be configured with a policy or one or more criteria for selecting a preferred adjacent GW for receiving traffic. The edge node can then use the SD-WAN NLRI 500 to advertise the properties of the selected adjacent GW to authorized peers of the edge node for enabling the peer to steer traffic to the edge node using the selected adjacent GW. The length field 504 specifies a length as described for the length field 404 in FIG. 4. The port-local-ID field 506 carries an edge node port identifier, which is connected to the GW. The SD-WAN-node-ID field 508 carries the IPv4 or IPv6 address of the edge node. As described above, the SD-WAN NLRI 500 can be encoded within an MP_REACH_NLRI Path Attribute (with SAFI=74) of an SD-WAN UPDATE message for advertising the detailed properties of the GWs for the edge node.

FIG. 6 is a diagram of an Adjacent Gateway sub-TLV 600 according to an embodiment of the present disclosure. The Adjacent Gateway sub-TLV 600 is used to identify the GWs connected to an edge node. In some embodiments, the Adjacent Gateway sub-TLV 600 can be carried in an iBGP extended community or SD-WAN-Hybrid Tunnel Encoding (Type =25) of a client route UPDATE message sent by the edge node.

The Adjacent Gateway sub-TLV 600 comprises a type field 602, a length field 604, a reserved field 606, a Egress GW Address Family field 608, and an address field 610. The type field 602 contains a value (TBD) to indicate that the TLV is an Adjacent Gateway sub-TLV. The length field 604 indicates the length of the remaining fields of the Adjacent Gateway sub-TLV 600 following the length field 604. The reserved field 606 is reserved for future use. The Egress GW Address Family field 608 indicates the address family (e.g., IPv4, IPv6, etc.) that the egress gateway supports for routing outgoing packets. The address field 610 carries one or more transit GW addresses of GWs connected to the edge node.

As shown above, using the edge discovery process 300, SD-WAN NLRI 500, and Adjacent Gateway sub-TLV 600, an edge node of an SD-WAN, using the control plane, can advertise information of the GW(s) directly connected to the edge node using BGP. Once an edge node of the SD-WAN obtains the information of the GW(s) directly connected to the other edge nodes of the SD-WAN, the edge node can use this information to steer a service or application traffic on the data plane from the edge node to another edge node along a SD-WAN path. To steer a service or application traffic in the data plane, Cloud GWs need to differentiate between packets destined towards their internal hosts/services, which require decryption by the transit nodes, and transit packets to be forwarded to the respective destination branch CPEs, which do not require decryption by the transit nodes. In accordance with the present disclosure, to differentiate between these types of packets, proper marking (i.e., additional data) is needed in the header of the packets.

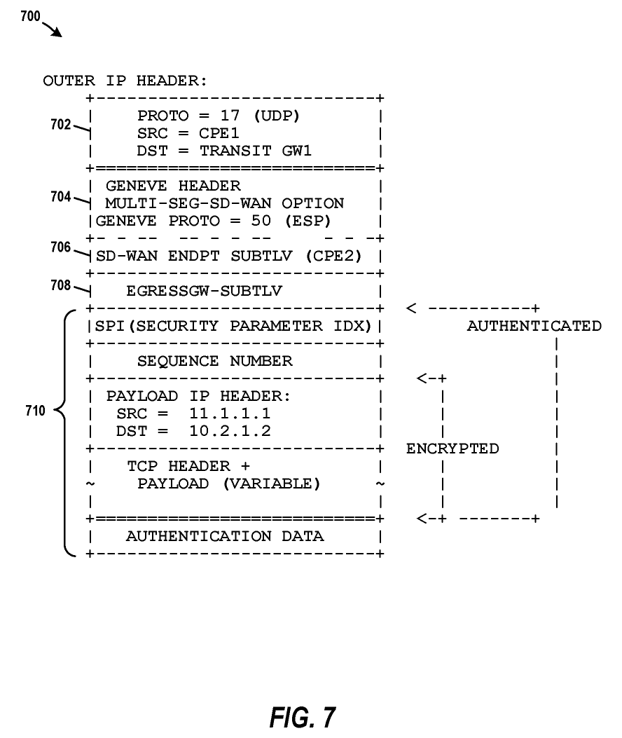

FIG. 7 is a diagram of a packet 700 according to an embodiment of the present disclosure. The packet 700 is an example encoding of a packet that is originated by a first CPE (e.g., CPE 104 in FIG. 1) and sent by the first CPE, in the data plane, along a SD-WAN path to a second CPE (e.g., CPE 106 in FIG. 1) using the IPsec ESP Tunnel Mode for encryption as described in FIG. 2. The packet 700 includes an outer IP header 702 that indicates an IP protocol type of the packet 700, a source IP address of the CPE originating the packet 700 (e.g., CPE1 as shown in FIG. 7) and a destination IP address indicating where to send the packet 700 (e.g., Transit GW1 as shown in FIG. 7).

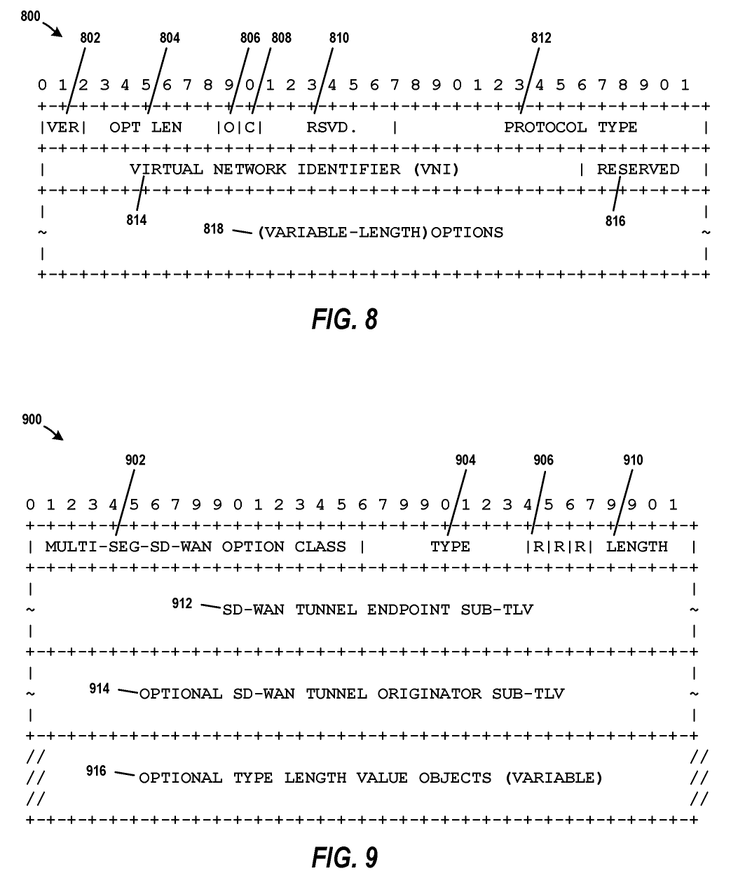

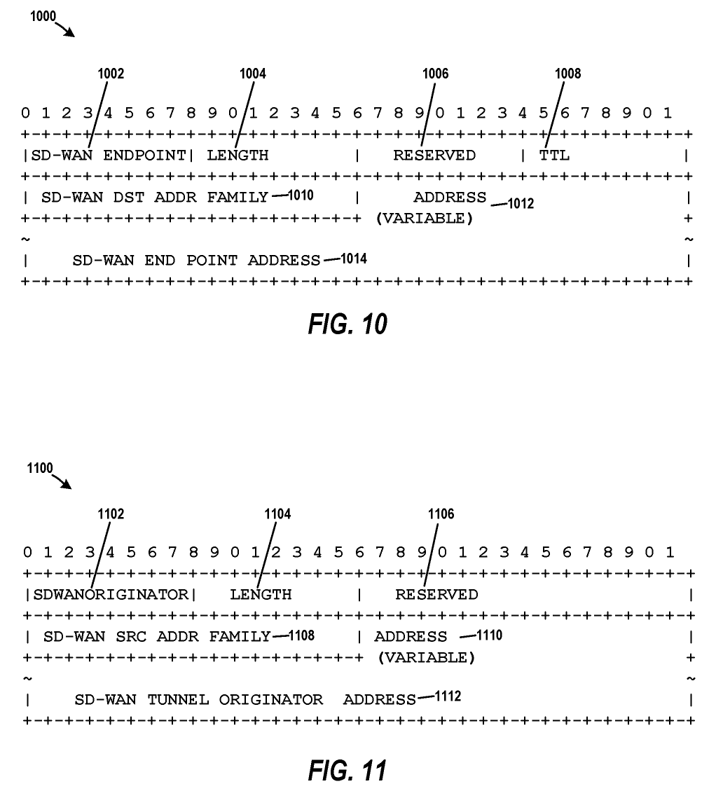

In the depicted embodiment, a GENEVE encapsulation header 704 is included in the packet 700 after the IP header 702 for enabling cloud GWs to steer IPsec encrypted packets among CPEs without decryption. The GENEVE encapsulation header (see FIG. 8) is supported by most cloud service providers and is described in RFC document 8926 titled “Geneve: Generic Network Virtualization Encapsulation” published November 2020 (RFC8926). A new GENEVE Option Class (Type value=TBD) is added to the GENEVE encapsulation header 704 to indicate the GENEVE encapsulation header 704 includes a multi-seg-SD-WAN Option Class (see FIG. 9) encoding. In the depicted embodiment, a protocol type field of the GENEVE encapsulation header 704 carries value = 50 (corresponding to the ESP protocol header as described in FIG. 2) to indicate the protocol data unit after the GENEVE encapsulation header 704 (i.e., the payload is IPsec ESP encrypted). A SD-WAN Endpoint sub-TLV 706 (see FIG. 10) and an Egress GW Sub-TLV 708 (see FIG. 11) are included in the multi-seg-SD-WAN Option Class encoding in the GENEVE encapsulation header 704. The SD-WAN Endpoint sub-TLV 706 indicates the destination CPE of the IPsec Tunnel (e.g., CPE2 as shown in FIG. 7). For the multi-segment SD-WAN via Cloud Backbone scenario, the originator CPE can use the Egress GW Sub-TLV 706 to specify the egress cloud GW for reaching the destination CPE. The remaining port 710 of the packet 700 is the ESP header, encrypted TCH header and payload, and authentication header as described in FIG. 2. In an embodiment, upon receiving the packet 700, the transit GW1 extracts the destination CPE from the GENEVE header 704 and encrypts the packet 700 with the IPsec SA2 to forward to the destination (e.g., CPE2 as shown in FIG. 7). The GENEVE header 704 is carried in the packet 700 to the CPE2.

FIG. 8 is a diagram of a GENEVE header 800 according to an embodiment of the present disclosure. The GENEVE header 800 may be used to encode the GENEVE encapsulation header 704 in FIG. 7. The GENEVE header 800 comprises a version field 802, Optional Length field 804, O field 806, C field 808, RSVD field 810, Protocol type field 812, Virtual Network Identifier (VNI) field 814, Reserved field 816, and (Variable-Length) Options field 818. The version field 802 (2 bits) indicates the current version number = 0. In an embodiment, packets received by a tunnel endpoint with an unknown version must be dropped. In an embodiment, transit devices interpreting GENEVE packets with an unknown version number must treat them as User Datagram Protocol (UDP) packets with an unknown payload. The Optional Length field 804 (6 bits) indicates the length of the option fields 818. The O field 806 (1 bit) indicates the packet contains a control message. Control messages are sent between tunnel endpoints. The C field 808 (1 bit) indicates critical options. If this bit is set, then tunnel endpoints must parse the options list to interpret any critical options. On tunnel endpoints where option parsing is not supported, the packet must be dropped on the basis of the C bit being set. The RSVD field 810 (6 bits) is reserved. The Protocol type field 812 (16 bits) indicates the type of protocol data unit appearing after the GENEVE header 800. The Virtual Network Identifier (VNI) field 814 (24 bits) carries an identifier of a unique element of a virtual network. In many situations, this may represent an L2 segment; however, the control plane defines the forwarding semantics of decapsulated packets. In some embodiments, the VNI may be used as part of Equal Cost Multipath (ECMP) routing mechanism forwarding decisions or may be used as a mechanism to distinguish between overlapping address spaces contained in the encapsulated packet when load balancing. The Reserved field 816 (8 bits) is also reserved. The (Variable-Length) Options field 818 carries GENEVE Option zero or more options encoded in TLV format. Each option consists of a 4-byte option header and a variable amount of option data interpreted according to the type. GENEVE options processing is described in RFC8926.

FIG. 9 is a diagram of a multi-seg-SD-WAN Option Class 900 according to an embodiment of the present disclosure. The multi-seg-SD-WAN option class 900 may be used to encode a GENEVE option in the GENEVE encapsulation header 704 as shown in FIG. 7. The multi-seg-SD-WAN option class 900 comprises a multi-seg-SD-WAN option class type field 902, a Type field 904, R fields 906, Length field 910, SD-WAN Tunnel Endpoint Sub-TLV field 912, Optional SD-WAN Tunnel Originator Sub-TLV field 914, and Optional Type Length Value objects (variable) field 916. The a multi-seg-SD-WAN option class type field 902 (Type value=TBD) indicates that the GENEVE option is a multi-seg-SD-WAN option class. The Type field 904 indicates the various types of multi-segment SD-WAN (Type value=TBD) such as Single Hop Transit SD-WAN, Multi-Hop Transit SD-WAN with explicitly specified egress Cloud GW, or Multi-Hop Transit SD-WAN without specified egress Cloud GW. The R fields 906 (3 bits) are reserved. The Length field 910 indicates the indicates the length of the multi-seg-SD-WAN option class 900 following the Length field 910. The SD-WAN Tunnel Endpoint Sub-TLV field 912 (see FIG. 10) indicates the destination CPE of the IPsec Tunnel. The Optional SD-WAN Tunnel Originator Sub-TLV field 914 carries zero or more SD-WAN Tunnel Originator Sub-TLV to indicate the originating CPE of the IPsec Tunnel. The Optional TLV objects (variable) field 916 carries zero or more sub-TLVs.

FIG. 10 is a diagram of a SD-WAN Tunnel Endpoint sub-TLV 1000 according to an embodiment of the present disclosure. The SD-WAN Tunnel Endpoint sub-TLV 1000 may be included in the SD-WAN Tunnel Endpoint Sub-TLV field 910 of the multi-seg-SD-WAN option class 900 in FIG. 9. The SD-WAN Tunnel Endpoint sub-TLV 1000 indicates the destination CPE of the IPsec Tunnel. For example, if there is a SD-WAN IPsec tunnel from CPE 104 to CPE 106 in FIG. 1, the SD-WAN Tunnel Endpoint sub-TLV 1000 can indicate the IP address of CPE 106 as the destination CPE of the IPsec Tunnel. The SD-WAN Tunnel Endpoint sub-TLV 1000 comprises a SD-WAN Endpoint type field 1002, a Length field 1004, a Reserved field 1006, a time-to-live (TTL) field 1008, a SD-WAN destination address family field 1010, and an address field 1012. The SD-WAN Endpoint type field 1002 (Type value=TBD) indicates that the TLV encoding is an SD-WAN Tunnel Endpoint sub-TLV. The Length field 1004 indicates the indicates the length of the SD-WAN Tunnel Endpoint sub-TLV 1000 following the Length field 1004. The Reserved field 1006 is reserved. The (TTL) field 1008 indicates a time to live value. In an embodiment, the TTL is set by the SD-WAN Tunnel Originator. Each transit node or transit region/zone (visible to the CPEs) should decrement the TTL so that the destination CPE can know the number of logical transit nodes (cloud regions or zones) the packet has traversed. Enterprises can also use TTL to set the maximum transit nodes/regions the packets traverse. The SD-WAN destination address family field 1010 indicates the address family (e.g., IPv4, IPv6, etc.) supported by the destination CPE of the IPsec Tunnel. The address field 1012 carries an SD-WAN end point address 1014 of the destination CPE of the IPsec Tunnel.

FIG. 11 is a diagram of a SD-WAN Tunnel Originator sub-TLV 1100 according to an embodiment of the present disclosure. The SD-WAN Tunnel Originator sub-TLV 1100 may be included in the Optional SD-WAN Tunnel Originator Sub-TLV field 914 of the multi-seg-SD-WAN option class 900 in FIG. 9. The SD-WAN Tunnel Originator sub-TLV 1100 indicates the originating CPE of the IPsec Tunnel. For example, if there is a SD-WAN IPsec tunnel from CPE 104 to CPE 106 in FIG. 1, the SD-WAN Tunnel Originator sub-TLV 1100 can indicate the IP address of CPE 104 as the originating CPE of the IPsec Tunnel. In some embodiments, the SD-WAN Tunnel Originator sub-TLV 1100 in the GENEVE header can assist transit nodes in applying appropriate policies when forwarding the packet.

The SD-WAN Tunnel Originator sub-TLV 1100 comprises a SD-WAN Tunnel Originator type field 1102, a Length field 1104, a Reserved field 1106, a SD-WAN source address family field 1108, and an address field 1110. The SD-WAN Tunnel Originator type field 1102 (Type value=TBD) indicates that the TLV encoding is an SD-WAN Tunnel Originator sub-TLV. The Length field 1104 indicates the indicates the length of the SD-WAN Tunnel Originator sub-TLV 1100 following the Length field 1104. The Reserved field 1106 is reserved. The SD-WAN source address family field 1110 indicates the address family (e.g., IPv4, IPv6, etc.) supported by the originating CPE of the IPsec Tunnel. The address field 1112 carries an SD-WAN tunnel originator address of the originating CPE of the IPsec Tunnel.

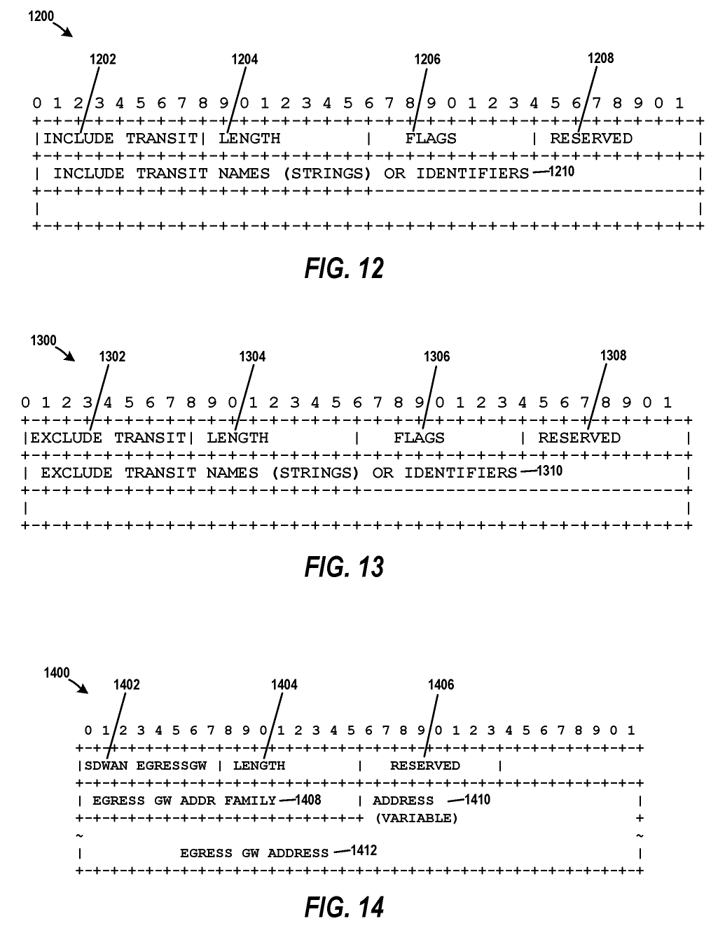

FIG. 12 is a diagram of an Include Transit Sub-TLV 1200 according to an embodiment of the present disclosure. The Include Transit Sub-TLV 1200 is an optional Sub-TLV for explicitly including a list of cloud availability transit nodes, regions, or zones in the SD-WAN path for reasons such as, but not limited to, regions having certain operations, administration, and management (OAM) and security functions for the improved visibility or to comply with regulations, etc. The Include Transit Sub-TLV 1200 comprises an Include Transit type field 1202, a Length field 1204, a flags field 1206, a reserved field 1208, and an include-transit names or identifiers field 1210. The Include Transit type field 1202 (Type value=TBD) indicates that the TLV encoding is an Include Transit Sub-TLV. The Length field 1204 indicates the indicates the length of the Include Transit Sub-TLV 1200 following the Length field 1204. The flags field 1206 can be used to set one more flags. In some embodiments, the flags field 1206 is used to indicate if the Include Transit-nodes are represented by names, or numeric identifiers. The reserved field 1208 is reserved. The include-transit names or identifiers field 1210 carries the names or identifiers of cloud availability regions or zones to be included in the SD-WAN path. Multiple Include Transit Sub-TLVs 1200 can be incorporated into a single GENEVE header to denote multiple nodes or regions intended for inclusion when steering the packet through the cloud backbone. It should be noted that the multiple Include Transit Sub-TLVs constitute a set rather than an ordered list.

FIG. 13 is a diagram of an Exclude Transit Sub-TLV 1300 according to an embodiment of the present disclosure. The Exclude Transit Sub-TLV 1300 is an optional Sub-TLV for explicitly excluding a list of cloud availability transit nodes, regions, or zones from the SD-WAN path for reasons such as, but not limited to, avoid regions that impose certain risks or to comply with regulations, etc. The Exclude Transit Sub-TLV 1300 comprises an Exclude Transit type field 1302, a Length field 1304, a flags field 1306, a reserved field 1308, and an exclude-transit names or identifiers field 1310. The Exclude Transit type field 1302 (Type value=TBD) indicates that the TLV encoding is an Exclude Transit Sub-TLV. The Length field 1304 indicates the indicates the length of the Exclude Transit Sub-TLV 1300 following the Length field 1304. The flags field 1306 can be used to set one more flags. In some embodiments, the flags field 1306 is used to indicate if the Exclude Transit-nodes are represented by names, or numeric identifiers. The reserved field 1308 is reserved. The exclude-transit names or identifiers field 1310 carries the names or identifiers of cloud availability regions or zones to be excluded from the SD-WAN path. Multiple Exclude Transit Sub-TLVs 1300 (i.e., a set) can be incorporated into a single GENEVE header to denote multiple nodes or regions intended for exclusion when steering the packet through the cloud backbone.

FIG. 14 is a diagram of an egress GW sub-TLV 1400 according to an embodiment of the present disclosure. In an embodiment, the egress GW sub-TLV 1400 may be included in the multi-seg-SD-WAN option class 900 in FIG. 9 as shown in the packet 700 in FIG. 7. For example, in some embodiments, for the multi-segment SD-WAN via cloud backbone scenario, the originator CPE can use the egress GW Sub-TLV 1400 to specify the Egress Cloud GW for reaching the destination CPE. The egress GW sub-TLV 1400 comprises an SD-WAN egress GW type field 1402, a Length field 1404, a Reserved field 1406, an Egress GW address family field 1408, and an address field 1410. The SD-WAN egress GW type field 1402 (Type value=TBD) indicates that the TLV encoding is an Egress GW Sub-TLV. The Length field 1404 indicates the indicates the length of the egress GW sub-TLV 1400 following the Length field 1404. The Reserved field 1406 is reserved. The Egress GW address family field 1408 indicates the address family (e.g., IPv4, IPv6, etc.) supported by the Egress GW for routing. The address field 1410 carries an egress GW address 1412.

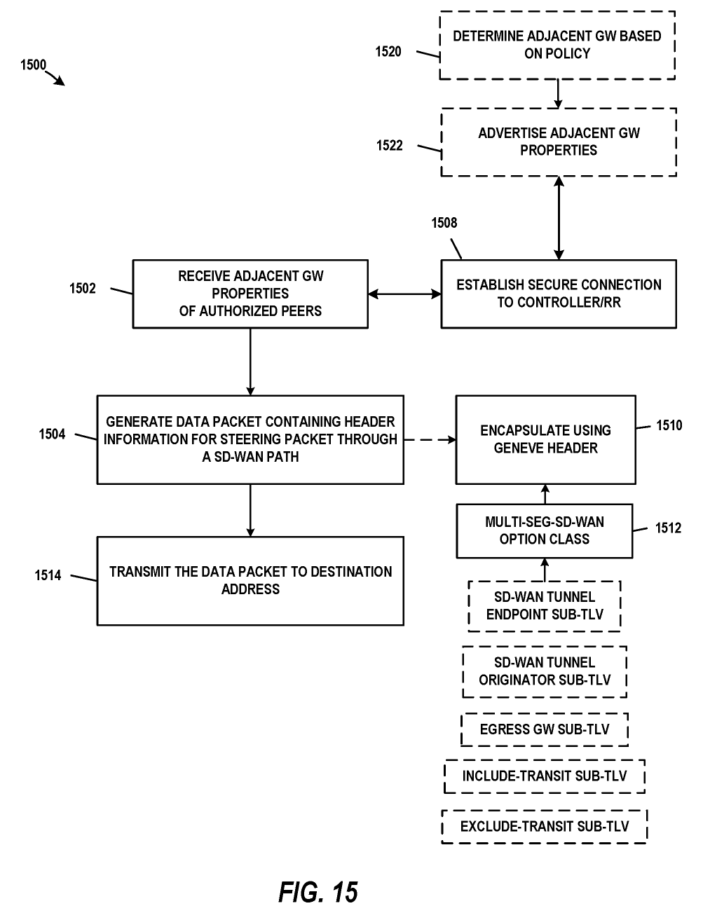

FIG. 15 is a flow chart of a process 1500 for SD-WAN TE according to an embodiment of the present disclosure. The process 1500 may be implemented by a first edge node of an SD-WAN (e.g., CPE 104 in FIG. 1). The first edge node, at step 1502, receives adjacent GW properties of a second edge node. The first edge node and the second edge node are configured as authorized peers in the SD-WAN (i.e., permitted network devices/edge nodes in the SD-WAN that may exchange communication). For example, CPE 104 may receive the adjacent GW properties of CPE 106 in FIG. 1 if they are authorized peers as determined by the SD-WAN controller/RR. In an embodiment, the adjacent GW properties from an authorized peer/edge node indicates a preferred/selected adjacent GW for sending traffic to the authorized peer. As described above, an edge node may be configured with a policy specifying one or more criteria for selecting a preferred adjacent GW for receiving traffic. The one or more criteria may include, but is not limited to, a shortest distance SD-WAN gateway to the first edge node, a lowest cost SD-WAN gateway of the first edge node, a most secure SD-WAN gateway of the first edge node, a most optimized SD-WAN gateway, or a SD-WAN gateway that satisfies a set of conditions.

In one embodiment, as described in FIG. 3, in order for the first edge node to receive the adjacent GW properties of its authorized peers, the first edge node, at step 1508, establishes a secure connection (e.g., an iBGP session) to a SD-WAN controller or RR. The controller/RR is configured to receive the adjacent GW properties from edge nodes of the SD-WAN (e.g., in one or more BGP UPDATE messages), determine the authorized peers the respective edge node, and propagate/send the adjacent GW properties to the authorized peers of the respective edge node. As described above, the adjacent GW properties may be advertised/carried in one or more BGP UPDATE messages including a client route UPDATE message and a SD-WAN UPDATE message. In some embodiments, the client route UPDATE message comprises an Encapsulation Extended Community and a Color Extended Community to link with a SD-WAN Tunnels UPDATE Message. In some embodiments, the Encapsulation Extended Community or a Tunnel-Encapsulation Path Attribute comprises a SD-WAN-Hybrid Tunnel Type Encoding to indicate mixed underlay networks. In some embodiments, the SD-WAN Hybrid Tunnel Type Encoding comprises an Adjacent-Gateway sub-TLV (see FIG. 6) to identify the selected adjacent GW of the edge node. In some embodiments, the SD-WAN UPDATE message comprises a SD-WAN NLRI (see FIG. 5) for advertising the adjacent GW properties of the edge node.

At step 1504, the first edge node generates a data packet containing header information, based on the received adjacent GW properties of the second edge node, for steering the packet to the second edge node through a SD-WAN path comprising the preferred/selected adjacent GW of the second edge node. As shown and described in FIG. 7 – FIG. 14, in some embodiments, generating the data packet comprises encapsulating, at step 1510, an encrypted payload of the data packet with a GENEVE encapsulation header (see FIG. 8). In some embodiments, at step 1512, the first edge node encodes a multi-segment SD-WAN option class (see FIG. 9) in the GENEVE encapsulation header. Optionally, as indicated by dashed lines in FIG. 15, in the multi-segment SD-WAN option class encoding, the first edge node can encode a SD-WAN Tunnel Endpoint sub-TLV (see FIG. 10) in the multi-segment SD-WAN option class to indicate a destination CPE of an IPsec Tunnel along the SD-WAN path, a SD-WAN Tunnel Originator sub-TLV (see FIG. 11) to indicate an originating CPE of an IPsec Tunnel, an Include Transit Sub-TLV (see FIG. 12) to explicitly include a first list of cloud availability transit nodes, regions, or zones in the SD-WAN path, an Exclude Transit Sub-TLV (see FIG. 13) to explicitly exclude a second list of cloud availability transit nodes, regions, or zones in the SD-WAN path, and/or an egress GW sub-TLV to specify an egress GW for reaching the destination CPE. As shown in FIG. 7 and FIG. 2, in some embodiments, the first edge node encrypts the payload of the data packet using IPsec ESP Tunnel Mode. At step 1514, the first edge node transmits the data packet to a next hop along the SD-WAN path as indicated by a destination address in an outer IP header of the data packet (see FIG. 7).

Optionally, as indicated by dashed lines in FIG. 15, the first edge node, at step 1520, may be configured to determine, based on a policy configured on the first edge node, an adjacent GW of the first edge node for receiving traffic from authorized peers of the first edge node. As described above, policy may specify one or more criteria for selecting a preferred adjacent GW for receiving traffic at the first edge node. Using a secure connection to the controller/RR, the first edge node advertises, at step 1522, adjacent gateway properties of the selected adjacent GW of the first edge node. As described above, the controller/RR is configured to determine the authorized peers of the first edge node and propagate the adjacent gateway properties of the selected adjacent GW of the first edge node to the determined authorized peers. It should be noted that steps 1520 and 1522 may be perform before, after, independently of, and/or in conjunction with steps 1502 to 1514.

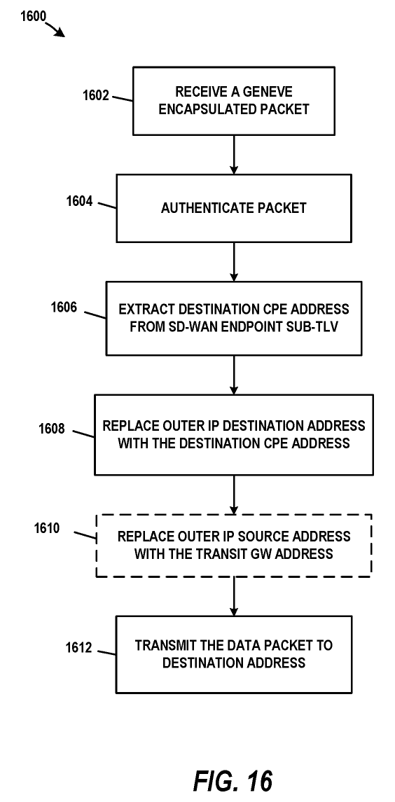

FIG. 16 is a flow chart of a process 1600 for SD-WAN TE according to an embodiment of the present disclosure. The process 1600 may be implemented by a Transit GW or transit node of an SD-WAN (e.g., GW 110 in FIG. 1). The transit GW, at step 1602, receives a GENEVE encapsulated packet. In an embodiment, the GENEVE encapsulated packet has a GENEVE Protocol Type = 50 (ESP) to indicate that the payload of the GENEVE encapsulated packet is encrypted using IPsec ESP. At step 1604, the transit GW authenticates the packet because the packet may have been sent over the Internet as an underlay network. In an embodiment, the transit GW authenticates the packet using a preconfigured authentication method. For example, in some embodiments, transit GW authenticates the packet using a digital signature or HMAC to verify that the packet has not been tampered with prior to the transit GW receiving the packet. At step 1606, the transit GW extracts the destination CPE address from the GENEVE header of the packet. For example, the destination CPE address may be in a SD-WAN Tunnel Endpoint sub-TLV in a multi-segment SD-WAN option class encoding of the GENEVE encapsulated packet (see FIG. 9 and FIG. 10). The transit GW, at step 1608, replaces the outer IP destination address with the destination CPE address. The GENEVE header remains unchanged in the GENEVE encapsulated packet. Optionally, in some embodiments, the transit GW, at step 1610, replaces the outer IP source address with the Transit GW address. At step 1612, the transit GW transmits the GENEVE encapsulated packet to a next hop along the SD-WAN path as indicated by the outer IP destination address of the GENEVE encapsulated packet. When the destination CPE receives the GENEVE encapsulated packet, the destination CPE performed the normal decryption and authentication methods to obtain the payload.

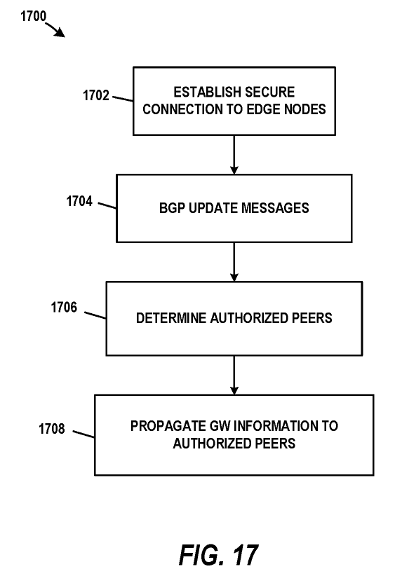

FIG. 17 is a flow chart of a process 1700 for SD-WAN TE according to an embodiment of the present disclosure. The process 1700 may be implemented by a SD-WAN controller or RR (e.g., controller 142 or RR 136 in FIG. 1). The controller, at step 1702, establishes secure connections to edge nodes of the SD-WAN. As stated above, for an edge node with both MPLS and IPsec paths, the edge node may already have a secure connection to the controller, in which case the existing secure connection may be used for the edge discovery process. In some embodiments, for an edge node that is only accessible via the Internet, the edge node, upon power-up, is configured to establish a secure tunnel (such as TLS or SSL) with the controller whose address is preconfigured on the edge node. In some embodiments, the BGP UPDATE messages comprise a client route UPDATE message and a SD-WAN UPDATE message as described herein. In some embodiments, the client route UPDATE message may include an Encapsulation Extended Community and a Color Extended Community (see RFC9012) to link with a SD-WAN Tunnels UPDATE Message. In some embodiments, the Encapsulation Extended Community or a Tunnel-Encapsulation Path Attribute comprises a SD-WAN-Hybrid Tunnel Type Encoding to indicate mixed underlay networks. In some embodiments, the SD-WAN Hybrid Tunnel Type Encoding comprises an Adjacent-Gateway sub-TLV (see FIG. 6) identify an adjacent SD-WAN gateway of the first edge node. In some embodiments, wherein the SD-WAN UPDATE message comprises a SD-WAN NLRI for advertising the properties of the adjacent SD-WAN gateway.

The controller, at step 1704, receives BGP UPDATE messages comprising adjacent GW information of a first edge node. The controller, at step 1706, determines authorized peers of the first edge node. The controller, at step 1708, propagates the adjacent GW information to the authorized peers.

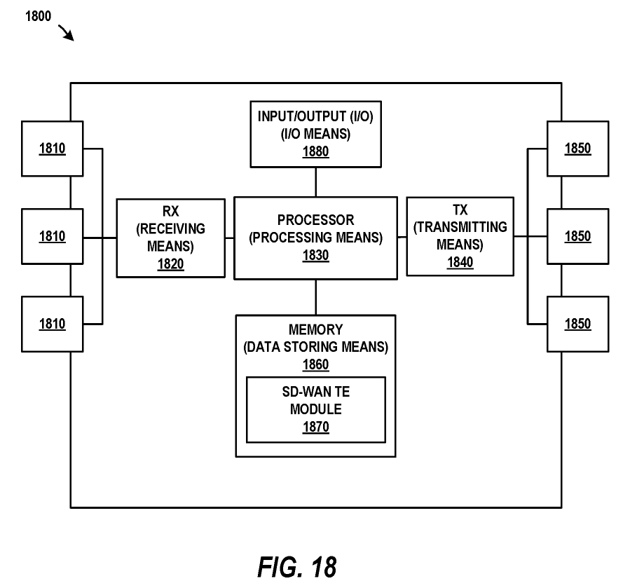

FIG. 18 is a diagram illustrating an apparatus 1800 according to an embodiment of the present disclosure. The apparatus 1800 can be used to implement embodiments of the present disclosure such as, but not limited to, a SD-WAN edge node, a SD-WAN controller or RR, or a transit GW or transit node. For example, the apparatus 1800 can be used to implement embodiments of the CPE 104, GW 110, controller 142, or RR 136 in FIG. 1. The apparatus 1800 includes receiver units (RX) 1820 or receiving means for receiving data via ingress ports 1810. The apparatus 1800 also includes transmitter units (TX) 1840 or transmitting means for transmitting via data egress ports 1850.

The apparatus 1800 includes a memory 1860 or data storing means for storing the instructions and various data. The memory 1860 can be any type of, or combination of, memory components capable of storing data and/or instructions. For example, the memory 1860 can include volatile and/or non-volatile memory such as read-only memory (ROM), random access memory (RAM), ternary content-addressable memory (TCAM), and/or static random-access memory (SRAM). The memory 1860 can also include one or more disks, tape drives, and solid-state drives. In some embodiments, the memory 1860 can be used as an over-flow data storage device to store programs when such programs are selected for execution, and to store instructions and data that are read during program execution.

The apparatus 1800 has one or more processors 1830 or other processing means (e.g., central processing unit (CPU)) to process instructions. The one or more processors 1830 may be implemented as one or more CPU chips, cores (e.g., as a multi-core processor), field-programmable gate arrays (FPGAs), application specific integrated circuits (ASICs), and digital signal processors (DSPs). The one or more processors 1830 are communicatively coupled via a system bus with the ingress ports 1810, RX 1820, TX 1840, egress ports 1850, and memory 1860. The one or more processors 1830 can be configured to execute instructions stored in the memory 1860. Thus, the one or more processors 1830 provide a means for performing any computational, comparison, determination, initiation, configuration, or any other action corresponding to the claims when the appropriate instruction is executed by the processor. In some embodiments, the memory 1860 can be memory that is integrated with the processor 1830.

In one embodiment, the memory 1860 stores a SD-WAN TE module 1870. The SD-WAN TE module 1870 includes data, executable instructions, and/or one more sub-modules for implementing the disclosed embodiments. Thus, the inclusion of the SD-WAN TE module 1870 substantially improves the functionality of the apparatus 1800.

Embodiments of the present disclosure provide at least the following technical advantages: decrease latency, avoid network segments that are prone to cyber-attacks or not compliant with the required regulations improve performance, and enable transit nodes to apply its installed network functions for performance monitoring or security scrubbing.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the disclosure is not to be limited to the details given herein. For example, the various elements or components may be combined or integrated in another system or certain features may be omitted, or not implemented. Additionally, the contact plan information may be encoded other types of IPv6 extension headers such as, but not limited to, hop-by-hop options, and other types of routing headers. The present disclosure is intended to cover the carrying of contact plan information and routing information in any of such extension headers.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A first edge node of a Software-Defined Wide Area Network (SD-WAN), the first edge node comprising:
memory configured to store instructions;
one or more processors coupled to the memory and configured to execute the instructions to cause the first edge node to:
receive, on a control plane, first gateway (GW) properties of a first adjacent SD-WAN gateway of a second edge node of the SD-WAN, wherein the first edge node is an authorized peer of the second edge node, and wherein the first adjacent SD-WAN gateway satisfies a first policy of the second edge node;
generate, based on the first GW properties, a data packet containing header information for steering the data packet to the second edge node through a SD-WAN path comprising the first adjacent SD-WAN gateway; and
transmit, on a data plane, the data packet to a next hop along the SD-WAN path as indicated by an outer Internet Protocol (IP) destination address of the data packet.

2. The first edge node of claim 1, wherein the one or more processors are configured to execute the instructions to further cause the first edge node to:
select, based on a second policy of the first edge node, a second adjacent SD-WAN gateway from a plurality of adjacent SD-WAN gateways of the first edge node; and
advertise second GW properties of the second adjacent SD-WAN gateway.

3. The first edge node of claim 2, wherein the first policy or the second policy comprises selecting at least one of a shortest distance SD-WAN gateway to the first edge node, a lowest cost SD-WAN gateway of the first edge node, a most secure SD-WAN gateway of the first edge node, or a most optimized SD-WAN gateway.

4. The first edge node of claim 1, wherein the one or more processors are configured to execute the instructions to further cause the first edge node to encode the first GW properties in at least one of a client route UPDATE message and a SD-WAN UPDATE message.

5. The first edge node of claim 4, wherein the client route UPDATE message comprises an Encapsulation Extended Community and a Color Extended Community to link with a SD-WAN Tunnels UPDATE Message, and wherein a SD-WAN-Hybrid Tunnel Type Encoding is added and used by the Encapsulation Extended Community or a Tunnel-Encapsulation Path Attribute to indicate mixed underlay networks.

6. The first edge node of claim 5, wherein the SD-WAN-Hybrid Tunnel Type Encoding comprises an Adjacent-Gateway Sub-Type-Length-Value (sub-TLV) to identify the first adjacent SD-WAN gateway.

7. The first edge node of claim 4, wherein the SD-WAN UPDATE message comprises a SD-WAN network layer reachability information (NLRI) for advertising the first GW properties of the first adjacent SD-WAN gateway.

8. The first edge node of claim 1, wherein the one or more processors are configured to execute the instructions to further cause the first edge node to generate the data packet by:
encapsulating an encrypted payload of the data packet with a Generic Network Virtualization Encapsulation (GENEVE) encapsulation header;
encoding a multi-segment SD-WAN option class in the GENEVE encapsulation header; and
encoding a SD-WAN Tunnel Endpoint sub-TLV in the multi-segment SD-WAN option class to indicate a destination customer premises equipment (CPE) of an IP Security (IPsec) Tunnel along the SD-WAN path.

9. The first edge node of claim 8, wherein the one or more processors are configured to execute the instructions to further cause the first edge node to encode a SD-WAN Tunnel Originator sub-TLV in the multi-segment SD-WAN option class to indicate an originating CPE of the IPsec Tunnel.

10. The first edge node of claim 8, wherein the one or more processors are configured to execute the instructions to further cause the first edge node to encode an Include Transit Sub-TLV in the multi-segment SD-WAN option class to explicitly include a first list of cloud availability transit nodes, regions, or zones in the SD-WAN path.

11. The first edge node of claim 8, wherein the one or more processors are configured to execute the instructions to further cause the first edge node to encode an Exclude Transit Sub-TLV in the multi-segment SD-WAN option class to explicitly exclude a second list of cloud availability transit nodes, regions, or zones in the SD-WAN path.

12. The first edge node of claim 8, wherein the one or more processors are configured to execute the instructions to further cause the first edge node to encode an egress GW sub-TLV in the multi-segment SD-WAN option class to specify an egress GW for reaching the destination CPE.

13. The first edge node of claim 8, wherein the one or more processors are configured to execute the instructions to further cause the first edge node to encode encrypt the encrypted payload of the data packet using IPsec Encapsulating Security Payload (ESP) Tunnel Mode.

14. A method implemented by a transit gateway (GW) of a Software-Defined Wide Area Network (SD-WAN), the method comprising:
receiving a Generic Network Virtualization Encapsulation (GENEVE) encapsulated packet;
authenticating the GENEVE encapsulated packet;
extracting a destination customer premises equipment (CPE) address from the GENEVE encapsulated packet;
replacing an outer Internet Protocol (IP) destination address of the GENEVE encapsulated packet with the destination CPE address; and
transmitting the GENEVE encapsulated packet to a next hop along a SD-WAN path as indicated by the outer IP destination address.

15. The method of claim 14, further comprising replacing an outer IP source address of the GENEVE encapsulated packet with an address of the Transit GW.

16. The method of claim 14, further comprising extracting the destination CPE address from a SD-WAN Tunnel Endpoint sub-TLV in a multi-segment SD-WAN option class encoding of the GENEVE encapsulated packet.

17. The method of claim 14, wherein the GENEVE encapsulated packet indicates a GENEVE Protocol Type value of 50 corresponding to IP Security (IPsec) Encapsulating Security Payload (ESP).

18. A Software-Defined Wide Area Network (SD-WAN) controller comprising:
memory configured to store instructions;
one or more processors coupled to the memory and configured to execute the instructions to cause the SD-WAN controller to:
establish secure connections to edge nodes of the SD-WAN;
receive Border Gateway Protocol (BGP) UPDATE messages comprising adjacent gateway (GW) information of an adjacent SD-WAN gateway of a first edge node, wherein the adjacent SD-WAN gateway satisfies a policy of the first edge node;
determine authorized peers of the first edge node; and
propagate the adjacent GW information to the authorized peers.

19. The SD-WAN controller of claim 18, wherein the BGP UPDATE messages comprise a client route UPDATE message and a SD-WAN UPDATE message.

20. The SD-WAN controller of claim 19, wherein the client route UPDATE message comprises an Encapsulation Extended Community and a Color Extended Community to link with a SD-WAN Tunnels UPDATE Message, and wherein the Encapsulation Extended Community or a Tunnel-Encapsulation Path Attribute comprises a SD-WAN-Hybrid Tunnel Type Encoding to indicate mixed underlay networks.
